(19) United States
(12) Patent Application Publication
(10) Pub. No.: US 2008/0061570 A1
(43) Pub. Date: Mar. 13, 2008

(54) Food roasting apparatus

(76) Inventors: Desmond Dockins, Edmond, OK (US); Clay B. Dockins, Enid, OK (US)

Correspondence Address: DUNLAP CODDING & ROGERS, P.C., PO BOX 16370, OKLAHOMA CITY, OK, 73113, US

(21) Appl. No.: 11/518,717

(22) Filed: Sep. 11, 2006

(51) Int. Cl. B25B 7/00

(52) U.S. Cl. 294/4

(57) ABSTRACT

A food roasting apparatus for roasting a food item includes an elongated tubular rod, a food support assembly and a skewer. The tubular rod has a first end, a second end, and a passageway extending therebetween. The food support assembly is formed from a continuous piece of material. The food support assembly has a first side, a second side and cross support member connecting the first and second side. At least one first ring member is positioned on the first side and at least one second ring member is positioned on the second side such that the first and second ring members cooperate to support the food item. The skewer has a first end and a second end. The skewer is slidably supported in the tubular rod such that the skewer is selectively movable between an extended position and a retracted position.

### CROSS-REFERENCE TO RELATED APPLICATIONS

Not applicable.

### BACKGROUND OF THE INVENTION

1. Field of the Invention

The present invention relates generally to cooking utensils and, more particularly, but not by way of limitation, to an improved cooking apparatus for roasting food over an open fire.

2. Description of the Related Art

Traditionally, a stick or other pointed apparatus is used for supporting and roasting food items such as hot dogs, sausages, wieners, marshmallows, and the like over an open fire while camping, picnicking or other similar occasions. The pointed end of the stick or other pointed apparatus is normally pushed through one or more food items. The stick or pointed apparatus is then handheld with the food item positioned over the fire so that the heat of the fire cooks the food.

One drawback to the use of a stick or pointed apparatus for this purpose, is that the food item sometimes falls from the stick or pointed apparatus during cooking or brushes against the burning logs or coals, thus contaminating the food. Additionally, it is often difficult to evenly rotate the food item over an open flame so as to cook the food item uniformly. Another shortcoming to the use of a stick or pointed apparatus, is the danger to the user, especially children, poking one another in the eye or body with the stick or pointed apparatus.

To this end, although food roasting devices of the existing art are operable, further improvements are desirable to enhance the ease of use of the food roasting apparatus. It is to such a roasting apparatus that the present invention is directed.

### BRIEF DESCRIPTION OF THE SEVERAL VIEWS OF THE DRAWINGS

FIG. 1 is a fragmental perspective view of a food roasting apparatus constructed in accordance with the present invention.

FIG. 2 is a fragmental perspective view of the food roasting apparatus constructed in accordance with the present invention, a distal end portion of a skewer being knurled.

FIG. 3 is a partially cutaway side elevational view of the food roasting apparatus of FIG. 1, the skewer disposed in an extended position.

FIG. 4 is a plan view of the food roasting apparatus of FIG. 1, the skewer of the food roasting apparatus disposed in an extended position.

FIG. 5 is a partially broken, partially cutaway plan view of the food roasting apparatus of FIG. 1, the skewer of the food roasting apparatus disposed in a retracted position.

FIG. 6 is a perspective view of a food support assembly detached from an elongated rigid tubular rod of the food roasting apparatus of FIG. 1.

FIG. 7 is a fragmental top plan view of a connector assembly for connecting the food support assembly to the elongated rigid tubular rod or body member of the food roasting apparatus of FIGS. 1 and 2.

FIG. 8 is a fragmental cross-sectional view of a stop assembly for resisting removal of the skewer from the elongated rigid tubular rod of the food roasting apparatus of FIGS. 1 and 2.

### DETAILED DESCRIPTION OF THE INVENTION

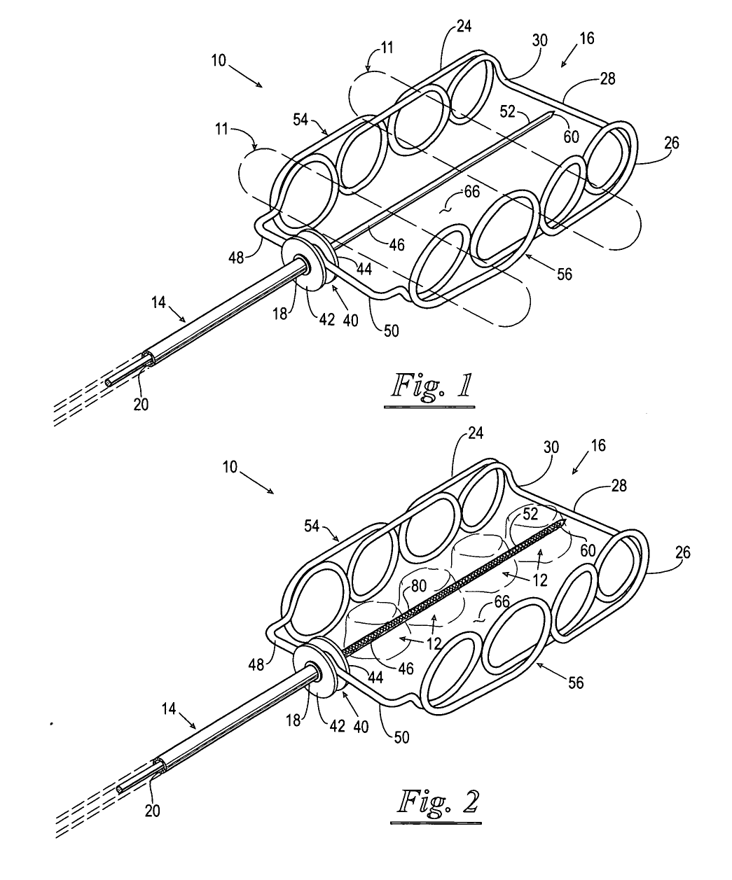

Referring now to the drawings, and more particularly to FIGS. 1-5, shown therein is a food roasting apparatus 10 constructed in accordance with the present invention. The food roasting apparatus 10 depicted in FIG. 1 has a plurality of hot dogs 11 (shown in phantom) supported thereon; and the food roasting apparatus 10 depicted in FIG. 2 has a plurality of marshmallows 12 (also shown in phantom) supported thereon. Although a plurality of hot dogs 11 is shown supported on the food roasting apparatus 10 in FIG. 1 and a plurality of marshmallows 12 is shown supported by the food roasting apparatus 10, it should be understood that the food roasting apparatus 10 can be used to roast any food items over an open fire that can be supported by the food roasting apparatus 10.

The food roasting apparatus 10 may be constructed of any material capable of withstanding high temperatures produced by an open fire. For example, the material used for construction of the food roasting apparatus 10 may be any non-toxic material, such as aluminum, steel, titanium and alloys containing such metals.

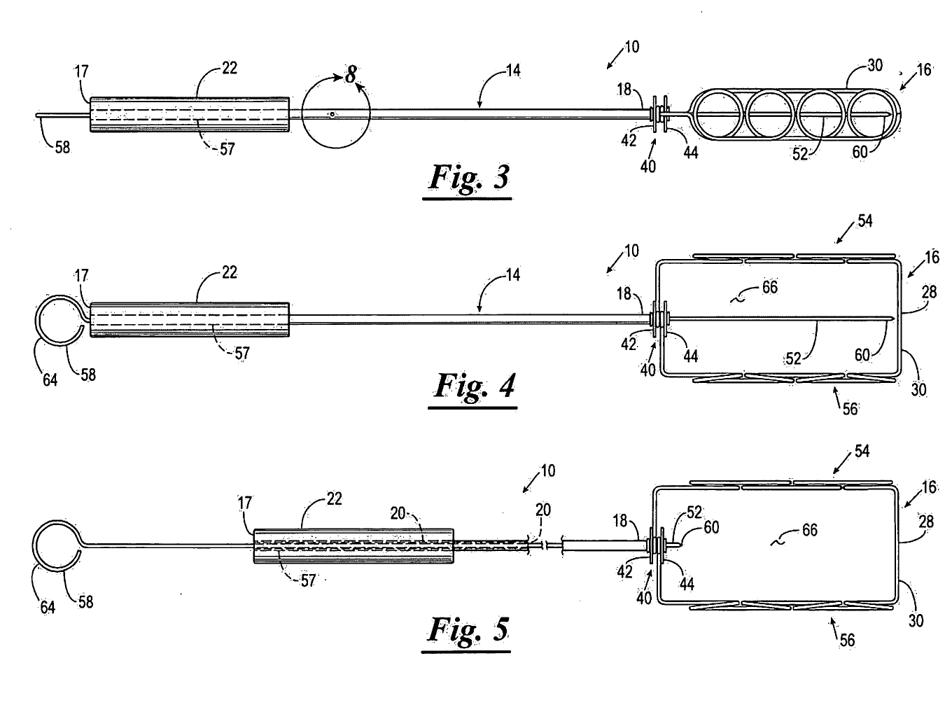

The food roasting apparatus 10 includes an elongated rigid tubular rod or body member 14 and a food support assembly 16. The tubular rod 14 has a first end 17, a second end 18 (FIGS. 3-5) and a passageway 20 (FIGS. 1, 2, 5 and 8) extending therebetween. A handle 22 (FIGS. 3-5 and 8) is affixed to the first end 17 of the elongated rigid tubular rod 14 of the food roasting apparatus 10. The handle 22 is desirably formed of wood, plastic or other thermally insulated materials which are capable of limiting the conduction of heat.

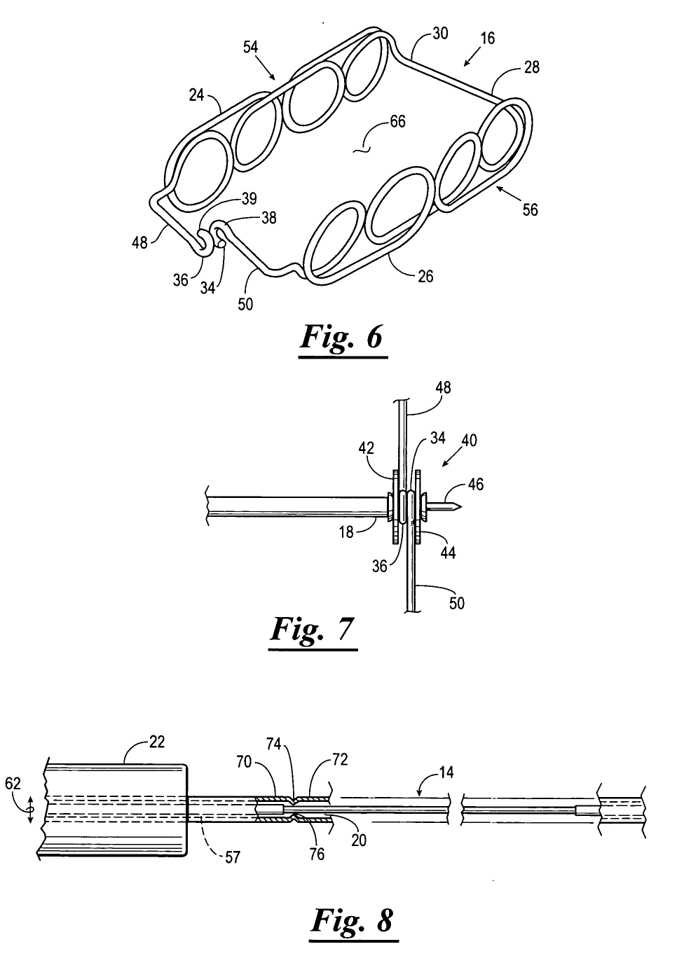

As more clearly shown in FIGS. 1, 2 and 4-6, the food support assembly 16 of the food roasting apparatus 10 is provided with a first side 24, a spatially disposed second side 26 and a cross-support member 28 interconnecting the first and second sides 24 and 26, of the food support assembly such that the first and second sides 24 and 26 of the food supporting assembly 16 are maintained in a stable, substantially parallel position. The food supporting assembly 16 is formed from a single continuous piece of wire 30 or other such material so that end portions 32 and 34 of the wire 30 are disposed substantially parallel to the cross-support member 28 and substantially perpendicular to the first and second sides 24 and 26 and define eyelets 36 and 38, (FIG. 6) for connecting the food support assembly 16 to the second end 18 of the elongated rigid tubular rod 14 via a connector assembly 40.

As more clearly shown in FIGS. 3-5 and 7, the connector assembly 40 is formed at or near the second end 18 of the elongated rigid tubular rod member 14 and includes a pair of spatially disposed flanges 42 and 44 having a shaft 46 (shown in phantom in FIG. 7) extending therebetween. A first shoulder member 48 is supported on the shaft 46 adjacent the flange 42 and a spatially disposed second shoulder member 50 is supported on the shaft 46 adjacent the second flange 44. The eyelets 36 and 38 provided on the end portions 32 and 34 of the wire 30 are sized and configured to be disposed about a portion of the shaft 46 extending between the first and second shoulder members 48 and 50 substantially as shown. Thus, the first and second shoulder members 48 and 50, in combination with the flanges 42 and 44, the shaft 46 extending therebetween and the eyelets 36 and 38 provided on the end portions 32 and 34 of the wire 30 cooperate to frictionally secure the food support assembly 16 to the second end 18 of the elongated rigid tubular rod 14. Further, the disposition of the eyelets 36 and 38 formed on the end portions 32 and 34 of the wire 30, and their connection about the shaft 46 formed between the first and second shoulder members 48 and 50 permits substantially unrestricted access to the passageway 20 extending through the elongated rigid tubular rod 14 so that a skewer 52 can be selectively moved in a to and fro position through the passageway 20 of the elongated rigid tubular rod 14 whereby the skewer 52, which will be described in more detail hereinafter, is selectively positionable in an extended position (FIGS. 1-4) and a retracted position (FIGS. 5 and 7).

Referring now to FIGS. 1 and 6, the wire 30 is formed into a plurality of first ring members 54 extending along the first side 24 of the food support assembly 16 and into a plurality of second ring members 56 extending along the second side 26 of the food support assembly 16. The plurality of first ring members 54 are substantially aligned along the first side 24 of the food support assembly 16 in a longitudinal direction and the plurality of second ring members 56 are substantially aligned along the second side 26 of the food support member 16 in a longitudinal direction. Each of the plurality of second ring members 56, which are spatially disposed from each of the plurality of first ring member 54, is substantially axially aligned with one of the plurality of first ring members 54 substantially as shown in FIGS. 1, 2 and 6. Thus, each of the plurality of first and second ring members 54 and 56 cooperate to receive and hold elongated food items which can be disposed through the plurality of aligned first and second ring members 54 and 56, such as the hotdogs 11 shown in phantom in FIG. 1.

The handle 22 is provided with an elongated passageway 57 extending through the handle 22 substantially as shown in phantom in FIGS. 3-5 and 8. A portion of the elongated rigid tubular rod 14 can be disposed within the passageway 57 of the handle 24 via the first end 17 thereof can be connected to the elongated rigid tubular member 14 so that the passageway 57 in the handle 22 is aligned with the passageway 20 extending through the elongated rigid tubular member 14 and unrestricted access is provided to the passageway 20 of the elongated rigid tubular rod 14 for reasons which will be described in more detail hereinafter.

The food support assembly 16 further includes the skewer 52 which is slidably disposed in the passageway 20 of the elongated rigid tubular rod 14 such that the skewer 52 is selectively movable between a first or extended position (FIGS. 1-4) and a second or retracted position (FIGS. 5 and 7). The skewer 52 may also be rotated within the elongated tubular rod 14 so as to evenly cook food items, such as marshmallows, peppers, etc., supported on.

The skewer 52 as depicted in FIGS. 1, 3-5 and 7, and which is slidably supported within the passageway 20 of the elongated tubular rod 14, has a first end portion 58, a second end portion 60, and a reduced diameter portion 62 positioned between the first end portion 58 and the second end portion 60 of the skewer 52 (FIG. 8). A control member 64 is formed or provided on the first end portion 58 of the skewer 52 so that a person can selectively move the skewer 52 between the extended position and the retracted position and also permit the person to rotate the skewer 52 so as to evenly cook items supported on the skewer 52 over an open fire.

In the extended position, the skewer 52 extends outwardly from the second end 18 of the elongated rigid tubular rod 14 such that the second end portion 60 of the skewer 52 is disposed substantially adjacent the cross-support member 30 of the food support assembly 16 substantially as shown in FIGS. 1-4. In a retracted position, a portion of the skewer 52 is withdrawn from the passageway 20 of the elongated rigid tubular rod 14 whereby a space 66 between the plurality of first and second ring members 54 and 56 is substantially void of the skewer 52 substantially as shown in FIG. 5. The control member 50 provided on the first end portion 58 of the skewer 40 enables a user to readily move the skewer 52 between the extended and retracted position, as well as rotate the skewer 52.

To prevent undesired removal of the skewer 52 from the passageway 20 of the elongated rigid tubular rod 14 when the skewer 52 is moved to the retracted position, the food roasting apparatus 10 is further provided with a skewer stop assembly 68. As more clearly shown in FIG. 8, the skewer stop assembly 68 includes spatially disposed shoulders 70 and 72 formed on the skewer 52 at the respective ends of the reduced diameter portion 62 of the skewer 52 and an indentation 74 formed in the elongated rigid tubular rod 14 so as to provide a reduced diameter portion 76 in the passageway 20 of the elongated rigid tubular rod 14. The indentation 74 is formed in the elongated rigid tubular rod 14 such that the indentation 74 is located between the shoulders 70 and 72 formed on the skewer 52. Thus, when the skewer 52 is moved to the extended position the movement of the skewer 52 can be limited by either the shoulder 70 formed on the skewer 52 engaging the indentation 74 formed in the elongated rigid tubular rod 14 or the control member 64 engaging the handle 22; whereas, when the skewer 52 is moved to the retracted position unintentional removal of the skewer 52 is prevented by the shoulder 72 formed on the skewer 52 engaging the indentation 74 formed in the elongated rigid tubular rod 14.

The second end portion 60 of the skewer 52 can be provided with a knurled surface 80 (see FIG. 2) to enhance support of items to be roasted thereon. For example, the knurled surface 80 provided on the second end portion 60 of the skewer 52 may stabilize food items, such as marshmallows, positioned on the second end portion 60 of the skewer 52, so that the food items can be rotated by turning the skewer 52 during the roasting process.

It should be understood that the surface of the second end portion 60 of the skewer 52 is not to be limited to a relatively smooth surface as shown in FIGS. 1, 3-5 and 7, or the knurled surface 80 as shown in FIG. 2. Further, if desired the surface of the entire length of the skewer 52 can be altered without departing from the scope of the present invention.

In use, the person selects a desired food item for roasting, such as hot dogs 11 (FIG. 1) or marshmallows 12 (FIG. 2). With one hand, the person grips the handle 22 of the food roasting apparatus 10 and with the other hand disposes an elongated food item, such as the hot dog 11, through one of the aligned first and second ring members 54 and 56 of the food support assembly 16 such that the hot dog 11 extends across a portion of the space 66 between the first and second ring members 54 and 56. The person then grips the control member 64 and pushes the skewer 52 in a forward direction so that the skewer 52 is moved to the extended position. That is, the second end portion 60 of the skewer 52 extends from the passageway 20 of the elongated rigid tubular member 14 into the space 66 and pierces the hot dog 11. Thus, the skewer 52 cooperates with the first and second ring members 54 and 56 of the food support assembly 16 to support and hold the hot dog 11. The person may repeat the process to utilize the remaining or a desired number of the first and second ring members 54 and 56. Once the desired number of first and second ring members 54 and 56 is utilized, the person places the food supporting assembly 16 of the food roasting apparatus 10 over a fire to cook the hot dog 11.

When the person is finished cooking the hot dog 11, the person grips the control member 64 and pulls the skewer 52 in a backward direction away from the space 60 between the first and second ring members 54 and 56 (i.e. moves to skewer 52 to the retracted position) until the skewer 52 releases the hot dog 11. The cooked hot dog 11 is then removed from the first and second ring members 54 and 56.

The food roasting apparatus 10 may also be used to roast other food items which do not require the use of the first and second ring members 54 and 56 of the food support assembly 16. For example, the food roasting apparatus 10 may be used to roast marshmallows 12, as shown in FIG. 2. When roasting food items such as the marshmallows 12, the person grips the control member 64 and pushes the skewer 52 in a forward direction (i.e. towards an extended position) so that the skewer 52 extends from the passageway 20 of the elongated rigid tubular rod 14, into the space 66 found between the first and the second ring members 54 and 56 and pierces the marshmallow(s) 12. Once the desired number of marshmallows 12 have been pierced by the skewer 52, the food support assembly 16 of the food roasting apparatus 10 is placed over a fire to roast the marshmallow(s) 12 or other food item.

When the person is finished roasting the marshmallow(s) 12, the person grips the control member 64 and pulls the skewer 52 in a backward direction away from the space 66 between the first and second ring members 54 and 56 (the skewer 52 is moved to the retracted position) where the second shoulder member 50 of the connector assembly 40 engages the marshmallows 12 and enhances removal of the marshmallows 12 from the second end portion 60 of the skewer 52.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A food roasting apparatus for roasting a food item, comprising:
an elongated rigid tubular rod having a first end, a second end, and a passageway extending therebetween;
a food support assembly connected to the tubular rod and formed from a continuous piece of material, the food support assembly having a first side, a second side and cross-support member connecting the first and second side, wherein at least one first ring member is positioned on the first side and at least one second ring member is positioned on the second side such that the first and second ring members cooperate to support the food item; and
a skewer having a first end and a second end wherein the skewer is slightly supported in the tubular rod such that the skewer is selectively movable between an extended position and a retracted position, in the extended position the skewer extends outwardly from the tubular rod such that the second end of the skewer is disposed substantially adjacent to the cross-support member and in the retracted position, the skewer is withdrawn from the tubular rod such that a space formed between the first and second ring members is free of the skewer.

2. The food roasting apparatus of claim 1 wherein a handle is supported by the first end of the elongated rigid tubular rod.

3. The food roasting apparatus of claim 1 wherein the first and second side of the food supporting assembly support a plurality of first and second ring members for supporting a plurality of food items.

4. The food roasting apparatus of claim 1 wherein the first end of the skewer has a control member for enabling a user of the food roasting apparatus to selectively move the skewer between the extended position and the retracted position.

5. The food roasting apparatus of claim 1 wherein the elongated rigid tubular rod is provided with an indentation extending into the passageway extending through the elongated rigid tubular rod and the skewer has a reduced diameter portion positioned between the first end and the second end of the skewer wherein the indentation and the reduced diameter portion cooperate to prevent the skewer from being removed from the passageway of the elongated rigid tubular rod.

6. The food roasting apparatus of claim 1 wherein the second end portion of the skewer is knurled.

7. The food roasting apparatus of claim 1 wherein the food support assembly is further characterized as having a first end portion and a second end portion, the first and second end portions disposed substantially parallel to the cross-support member and substantially perpendicular to the first and second sides of the food support assembly, and wherein the food roasting apparatus further comprises a connector assembly for connecting the first and second end portions of the food support assembly to the second end of the elongated rigid tubular rod of the food roasting apparatus.

8. The food roasting apparatus of claim 7 wherein the first and second end portions of the food support assembly are each provided with eyelets and wherein the connector assembly comprises:
a pair of spatially disposed flanges having a shaft extending therebetween, the pair of spatially disposed flanges and the shaft extending therebetween formed on the second end of the elongated rigid tubular rod of the food roasting apparatus such that the eyelets on the first and second end portions of the food support assembly are disposable between the spatially disposed flanges and about the shaft extending between the spatially disposed flanges whereby the eyelets cooperated with the spatially disposed flanges and the shaft extending therebetween to frictionally secure the food support assembly to the second end of the elongated rigid tubular rod of the food roasting apparatus.

9. The food roasting apparatus of claim 8 wherein a handle is supported by the first end of the elongated rigid tubular rod.

10. The food roasting apparatus of claim 9 wherein the first and second side of the food supporting assembly support a plurality of first and second ring members for supporting a plurality of food items.

11. The food roasting apparatus of claim 10 wherein the first end of the skewer has a control member for enabling a user of the food roasting apparatus to selectively move the skewer between the extended position and the retracted position.

12. The food roasting apparatus of claim 1 wherein the elongated rigid tubular rod is provided with an indentation extending into the passageway extending through the elongated rigid tubular rod and the skewer has a reduced diameter portion positioned between the first end and the second end of the skewer wherein the indentation and the reduced diameter portion cooperate to prevent the skewer from being removed from the passageway of the elongated rigid tubular rod.

13. The food roasting apparatus of claim 12 wherein the second end portion of the skewer is knurled.

14. The food roasting apparatus of claim 12 wherein the food support assembly is further characterized as having a first end portion and a second end portion, the first and second end portions disposed substantially parallel to the cross-support member and substantially perpendicular to the first and second sides of the food support assembly, and wherein the food roasting apparatus further comprises a connector assembly for connecting the first and second end portions of the food support assembly to the second end of the elongated rigid tubular rod of the food roasting apparatus.

15. The food roasting apparatus of claim 8 wherein the first and second side of the food supporting assembly support a plurality of first and second ring members for supporting a plurality of food items.

16. The food roasting apparatus of claim 8 wherein the first end of the skewer has a control member for enabling a user of the food roasting apparatus to selectively move the skewer between the extended position and the retracted position.

17. The food roasting apparatus of claim 8 wherein the food support assembly is further characterized as having a first end portion and a second end portion, the first and second end portions disposed substantially parallel to the cross-support member and substantially perpendicular to the first and second sides of the food support assembly, and wherein the food roasting apparatus further comprises a connector assembly for connecting the first and second end portions of the food support assembly to the second end of the elongated rigid tubular rod of the food roasting apparatus.

18. The food roasting apparatus of claim 8 wherein the second end portion of the skewer is knurled.
